(19) United States
(12) Patent Application Publication
(10) Pub. No.: US 2015/0047675 A1
(43) Pub. Date: Feb. 19, 2015

(54) System and Apparatus for Washing Vertical Surfaces and Related Methods

(71) Applicant: Dallas W. Simonette, Las Vegas, NV (US)

(72) Inventor: Dallas W. Simonette, Las Vegas, NV (US)

(21) Appl. No.: 13/970,341

(22) Filed: Aug. 19, 2013

(51) Int. Cl. B08B 3/14; B01D 35/02

(52) U.S. Cl. CPC B08B 3/14; B01D 35/02
USPC 134/18; 210/236; 134/110; 134/56 R; 29/890.14

(57) ABSTRACT

A system for delivering purified water is disclosed, comprising a pressure vessel with a first end and a second end, each end adapted to receive a single use water treatment cartridge, and first and second single use water treatment cartridges. The pressure vessel has a first cartridge adaptor at the first end, and a second cartridge adapter at the second end; a first quick connect coupling between the first cartridge and the first cartridge adaptor, and a second quick connect coupling between the second cartridge and the second cartridge adaptor. Methods of fabricating single use water treatment cartridges and using said cartridges to clean glass surfaces are disclosed.

### BACKGROUND

The present invention is a system for cleaning vertical surfaces, and in particular, cleaning glass surfaces and other transparent or semi-transparent surfaces.

There are many ways to wash vertical surfaces, such as windows. Known methods include using chemical washes such as ammonia-based cleaning fluids and hand tools such as a squeegee, which comprises an elongated sponge mounted on a handle that has an opposite side comprising an elongated elastomeric strip. Windows are washed by immersing the squeegee in the solution, applying the solution to the glass surface, scrubbing the glass surface and then removing the solution from the glass surface by passing the elastomeric strip over the surface. Any fluid remaining on the glass evaporates.

Systems that use chemicals can cause undesirable chemical exposure to the user, and can pollute the environment. Glass cleaning systems have been developed that eliminate the need to apply chemicals to the glass surfaces. These systems are more environmentally friendly, and eliminate user exposure to chemicals.

Cleaning systems that use purified water are capable of cleaning smooth surfaces such as glass without the use of chemicals. These systems deliver purified water to a brush or other device that applies frictional forces to mechanically loosen dirt and other debris. The purified water attracts the dirt and debris and carries the materials away from the surface. When the surface dries, it is free of water spots, smudges and smears.

There are several known ways to purify water for cleaning glass surface. Examples include distillation, the use of resin-based ion exchange systems and reverse osmosis (hereinafter R/O) systems. Distillation systems require a large amount of energy to operate. Ion exchange systems are costly and require the operator of the system to measure the flow and then regenerate the resin after a certain volume of water has been treated. R/O systems have become the water purification system of choice for cleaning glass, especially vertical glass systems.

An example of one such R/O glass cleaning system is described in U.S. Patent Publication No. 2012/0085687, assigned Ser. No. 13/247,438, and filed Sep. 28, 2011. The content of this published application is incorporated by reference in its entirety.

FIG. 1 of the published application shows a system that treats water in three separate stages. In the first stage, water passes through a pre-filter comprising a carbon block and sediment filter membrane. Carbon blocks are known in the art and can be purchased from Multipure Corporation of Las Vegas, Nev. An example of a suitable carbon block for window cleaning applications such as a 2½ inch diameter, by 5 inch length, 10 micron extruded carbon filter. The sediment filter membrane which is wrapped around the outside of the carbon block traps impurities such as large molecular weight organic molecules, and filters out dirt and other suspended particles. The carbon block removes chlorine from supply water. Water exiting the pre-filter is then treated in a second stage. The water exiting the carbon filter is then exposed to a reverse osmosis membrane. The R/O membrane separates water molecules from salts such as dissolved calcium, magnesium, silicate and other total dissolved solids. By creating a pressure gradient between each side of the membrane, water molecules permeate through the membrane and water rich in dissolved solids remains on the outer side of the membrane. Purified water passing through the membrane travels towards the core and exits to a third stage treatment process. The R/O membrane removes approximately 99% of the total dissolved solids present in the feed water.

The pressure gradient is maintained by providing a flow control valve on the concentrate exit port. This flow control valve maintains back pressure on the concentrate. Typically the flow is controlled at about 0.5 gpm to produce the desired amount of pure water. As long as the back pressure on the concentrate line is of a lower pressure than the supply pressure of water entering the R/O system, the system will allow water molecules to pass through the membrane.

Water exiting the R/O membrane core tube then enters a third stage which is a finishing process that includes a zone containing an ion exchange resin, which absorbs substantially all of the remaining total dissolved solids in the system. The water exiting the system is considered ultra-pure and suitable for cleaning glass without using chemicals.

An example of a prior art device that processes water in three separate stages is shown in FIG. 1. A pressure vessel 4 is provided that is substantially cylindrical, and contains a substantially cylindrical R/O filter 12 in a central portion of the vessel. A water source, such as an ordinary garden hose couples to water inlet 6 which contains a female hose thread. Water enters water inlet 6 and travels through cavity 8 to the outer surface of an internal carbon filter 7. The carbon filter 7 has a hollow core. Water flows through the filter into the core, and treated water flows out of the central core onto a first end the end of a second stage of treatment, which is a reverse osmosis (hereinafter R/O) membrane 12.

The R/O membrane is formed from a membrane that is adhered to a substrate layer to support the membrane. This two-layer system is rolled over a length of PVC tubing or other tubing that is perforated to allow treated water to accumulate and move through the central core. Concentrate stays on the outside of the membrane and is discharged through a port. Suitable R/O Membranes used for glass cleaning systems are commercially available from Axeon Water Technologies of Temecula, Calif.

Treated water passing through the core of the R/O membrane enters a third stage, which is a post-filtering system that comprises an ion-exchange resin. Purified water exits the system through port 16. Concentrated waste water accumulating on the outside surface of the R/O filter exits through a waste water flow regulator valve (not shown) and through and outlet port 18.

Window washing systems that supply pure water to pole-fed brushes and other window cleaning systems typically require a pure water flow rate of between 0.5 and 1.0 gallons per minute. Other washing systems can demand more or less water, such as between 0.3 gpm and 1.5 gpm.

R/O membranes that measure 40 inches in length and have an outer diameter of approximately 4 inches are known to have the capacity to deliver pure water within a desirable range of gallons per minute (gpm) for pole fed cleaning systems. Although flow through an R/O membrane depends upon temperature and pressure, for the vast majority of systems that use a household water supply such as well water or city water, R/O membranes of this size are able to deliver the required amount of water to efficiently clean glass surfaces.

Adding carbon pre-treatment filters and ion-exchange post-filters add over a foot of extra length to the pressure vessel, making it impractical for transport in an ordinary car. The extra length adds more weight to the system. The resulting system is too heavy and bulky for consumer use.

The carbon filters saturate with chlorine and need to be replaced in order to prevent damage to the R/O membrane. The ion exchange resins become saturated with dissolved minerals and eventually require regeneration or replacement. The R/O membranes eventually scale up and require acid cleaning or replacement. Unfortunately, the three systems can become inefficient at different times, requiring frequent maintenance. In particular, carbon and resin systems become ineffective at different rates. The resin system is typically rated for a certain amount of water being treated. The user must monitor the total volume of water being treated, disassemble the structure and replace the resin when the resin reaches the end of its useful life. Although the resin can be removed and regenerated, suppliers of the resin systems do not currently provide regeneration services. Regeneration would require separation of the anion and cation resin beads. The anions would be treated with a high acid solution and the anion resin beads would be treated with a high base solution. Both would then require a rinse with zero TDS water and then the resins would be recombined together into a mixed resin bed product for use.

### SUMMARY

A system for delivering purified water is disclosed. The system comprises a pressure vessel with a first end and a second end, each end adapted to receive a single use water treatment cartridge, and first and second single use water treatment cartridges. The pressure vessel has a first cartridge adaptor at the first end and a second cartridge adapter at the second end, a first quick connect coupling between the first cartridge and the first cartridge adaptor, and a second quick connect coupling between the second cartridge and the second cartridge adaptor.

A method of providing a system for cleaning smooth surfaces, such as vertical glass surfaces is disclosed. The method includes the steps of providing a pressure vessel with a first quick disconnect connection, a second quick disconnect connection and a waste water outlet, wherein the pressure vessel contains a reverse osmosis filter. The method includes providing a first cartridge containing carbon with an inlet connection adapted to connect to a water source and an outlet connection adapted to connect with the first quick disconnect connection. The method further includes the step of providing a second cartridge containing a resin material with an inlet connection adapted to connect with the second quick disconnect connection and an outlet adapted to connect to a water supply line of a washing appliance. According to the invention, the method includes providing instructions for connecting the first cartridge to a water source, connecting the first cartridge to the first quick disconnect connection of the pressure vessel, connecting an outlet connection of the second cartridge to a washing appliance, connecting an opposite end of the second cartridge to the second quick disconnect connection of the pressure vessel, and activating a water source, wherein treated water is delivered to the washing appliance.

Method of fabricating quick-disconnect water treatment cartridges is disclosed. The method includes forming a first section of the cartridge, the first section having an a cavity for receiving a water treatment media, a quick connect coupling structure and a joining surface; forming a second section of the cartridge, the second section having a cavity for receiving a water treatment media, and a joining surface; inserting and amount of water treatment media into at least one of the cavities sufficient to treat enough water for a single use residential application; joining together the joining surfaces; and fusing the joining surfaces together, forming a single use cartridge.

### DESCRIPTION OF DRAWINGS

FIG. 1 illustrates a prior art three-stage water treatment system.

FIG. 2 is a perspective view of a prior art water-fed brush on a telescoping pole.

FIG. 3 is a perspective view of the three-stage water treatment system of an embodiment of the present invention.

FIG. 4 is front-elevational view of a pressure vessel of one embodiment of the present invention.

FIG. 5 is a cross-sectional view of a pressure vessel of one embodiment of the present invention.

FIG. 6 is a detailed cross-sectional view of a first end of the pressure vessel of the present invention.

FIG. 7 is a detailed cross-sectional view of a second end of the pressure vessel of the present invention.

FIG. 8A is a perspective view of a disposable cartridge of an embodiment of the present invention.

FIG. 8B is a perspective view of a first end of the pressure vessel.

FIG. 9 is a perspective view of a first portion of a disposable cartridge of the present invention.

FIG. 10A shows a cartridge lockable in a second end of the pressure vessel of an embodiment.

FIG. 10B shows a perspective view of a second end of an embodiment of the invention.

FIG. 11 shows a cap of an embodiment of the present invention.

FIG. 12 illustrates a screen washing implement of the present invention, mounted on a pressure vessel.

FIG. 13 is a perspective view of the screen washing element.

FIG. 14 is a detailed view of a portion of the screen washing element.

FIG. 15 illustrates a plurality of pressure vessels and pole mounted brushes stored in a presentation rack.

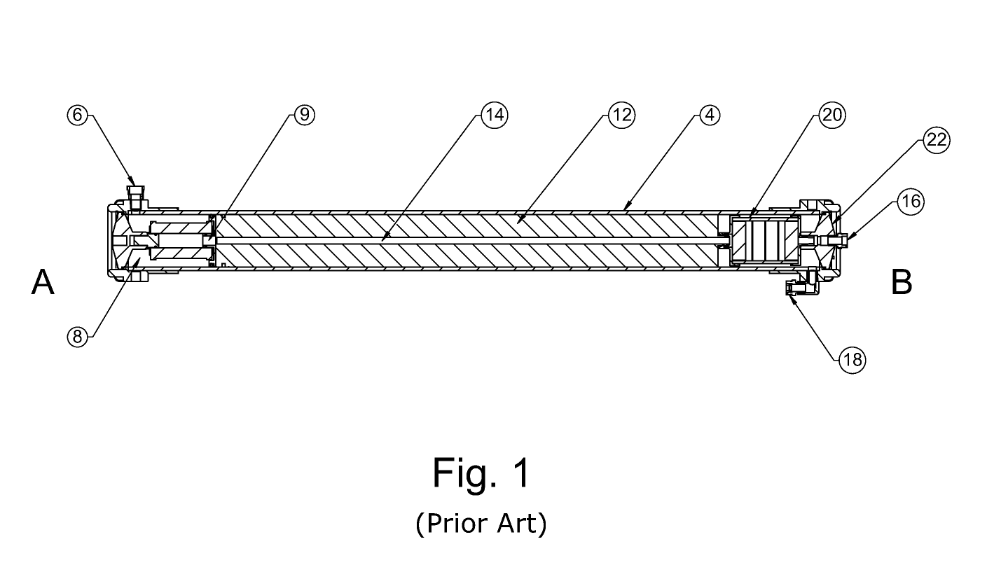

### DETAILED DESCRIPTION

The present invention is a compact, three-stage water treatment system and apparatus that are light weight, compact and suitable for consumer use. Advantageously, the water treatment system of the present invention utilizes first and third stage filters that can be easily installed by the consumer prior to each use, and then discarded after a single use. The second stage membrane can be used multiple times and does not require frequent monitoring of membrane efficiency or frequent maintenance. The efficiency of the first and third stage systems require no monitoring or maintenance, because they have more than enough the capacity to purify enough water to wash every window of a typical residential home.

The three-stage system of the present invention is capable of delivering very pure water to hand-held washing attachments such as water-fed pole systems that are currently used to clean smooth vertical surfaces such as window glass. Pole-fed systems allow the user to wash vertical surfaces from the ground, and without using ladders. Hand-held systems can be used to wash vehicles, and vehicle glass. Systems and apparatuses of the present invention are suitable for efficiently cleaning any smooth surface that is capable of unsightly spotting and streaking.

Systems of the present invention are capable of delivering between 0.5 and 1.0 gallons per minute of ultra pure water using most consumer water supplies such as well water and city water supplies, and at the same time deliver 35 feet of head, which allows the user to wash glass windows of a three story building from the ground. Since most consumers would prefer not to climb ladders to wash windows, systems of the present invention completely eliminate the need to use ladders. Using a pure water system is also environmentally friendly, because no chemicals fall to the ground. And because there are no chemicals, the user avoids chemical exposure which is undesirable from a health standpoint.

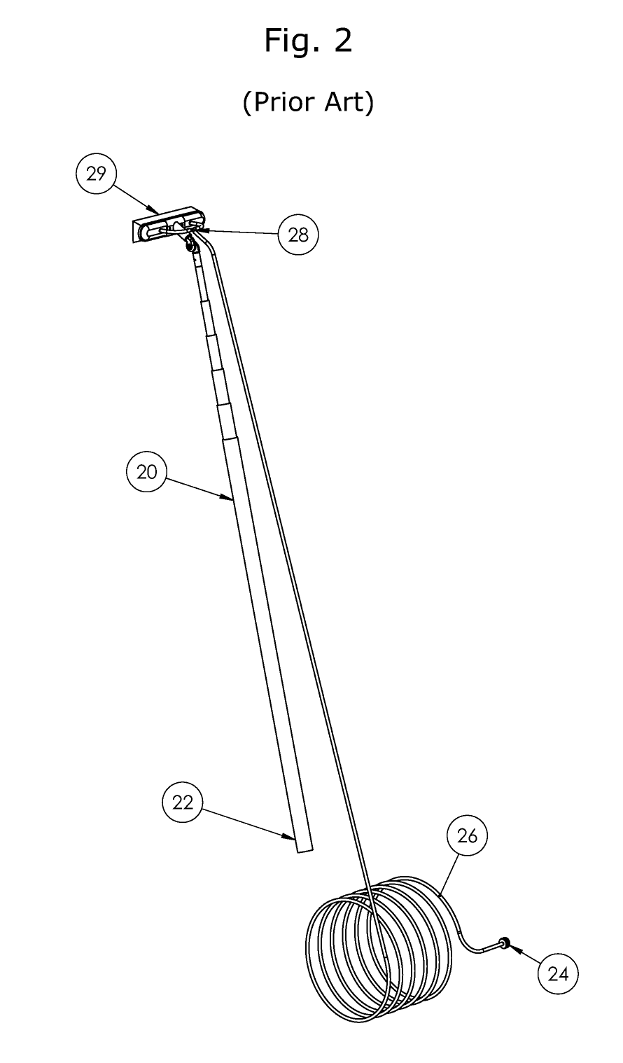

As shown in FIG. 2, a typical water-fed pole system includes a telescoping pole 20 made of rigid, lightweight material such as aluminum or fiberglass resin. At the proximal end 22 of the pole is a hose connection 24 that can be coupled to the pure water output of systems of the present invention. Preferably a length of hose 26 is provided such that the user can move away from the pressure vessel (not shown) and wash several windows without moving the pressure vessel.

At the distal end 28, an implement such as a soft-bristle brush 29 is provided that can be used to mechanically loosen dirt and debris from the smooth vertical surface. Other implements may be used, including a high pressure nozzle, a squeegee tool, a rotating mechanized brush or other structure to mechanically loosen dirt and debris.

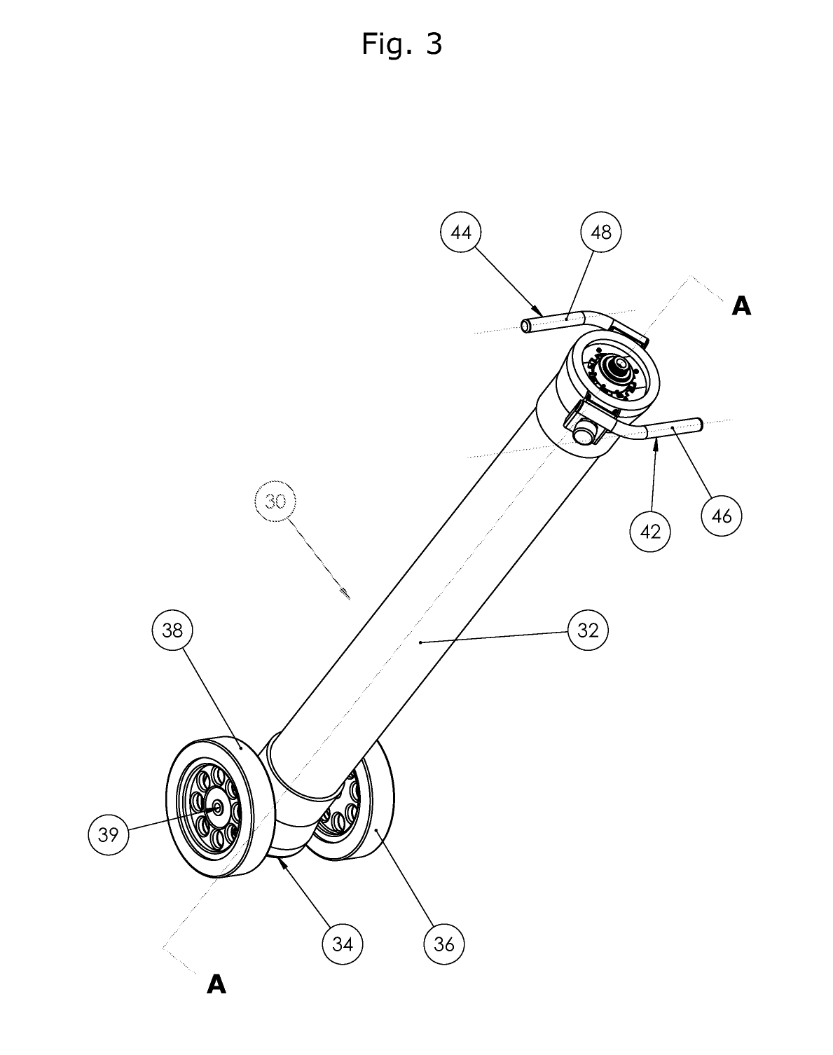

As shown in FIG. 3, a three-stage water treatment system 30 is provided. The system includes a pressure vessel 32. The pressure vessel 32 has a first end 34 that includes a set of mounted transport wheels 36, 38 mounted on separate, independent axles having a central wheel axis 39. At the opposite end 40 are first and second handles 42, 44. Either handle 42, 44 may be used to lift the opposite end 40 and move the pressure vessel 32 from place to place, as needed. Because the length of the vessel 33 is relatively short, i.e. about 42 inches, the user can easily lift the second end 40 and transport the vessel 30 by pulling the vessel to another location. Advantageously, the handles 42, 44 are mounted at a first end along a perimeter of the circular end. The handles are elongated and bend at an approximate 45 degree angle. The distal end of each handle is positioned along a central axis 46, 48, that is parallel to the axis of the wheel axis 39. This handle orientation relative to the wheels allows the distal end of each handle to rest on the same flat surface as the wheels when the vessel 30 is in the horizontal position.

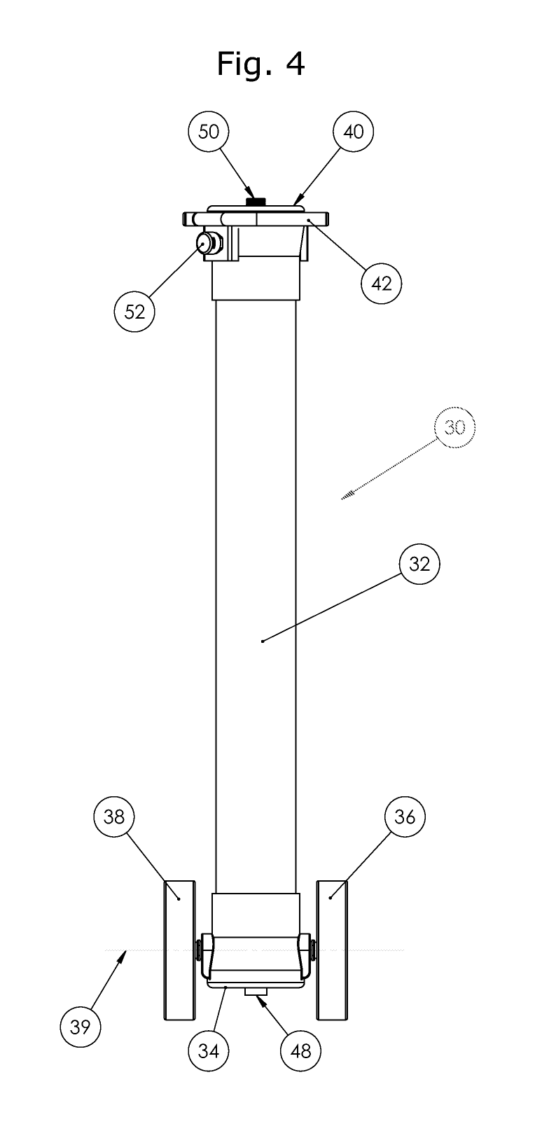

As shown in FIG. 4, an untreated water supply inlet 48 is provided at the first end. In one embodiment, the water supply inlet 48 is a female threaded garden hose connection. In other embodiments, this inlet 48 has a pipe thread connection, a quick disconnect coupling, a tube fitting or any other known means for connecting a water supply to the system 30.

The pressure vessel 32 has a second end 40 with a pure water outlet 50. The pure water outlet 50 may have a male threaded hose connection. In other embodiments, the outlet may include any type of known connection for connecting a water outlet line to the system 30. A concentrate port 52 is provided with a flow control valve and diffuser which will be described in greater detail below.

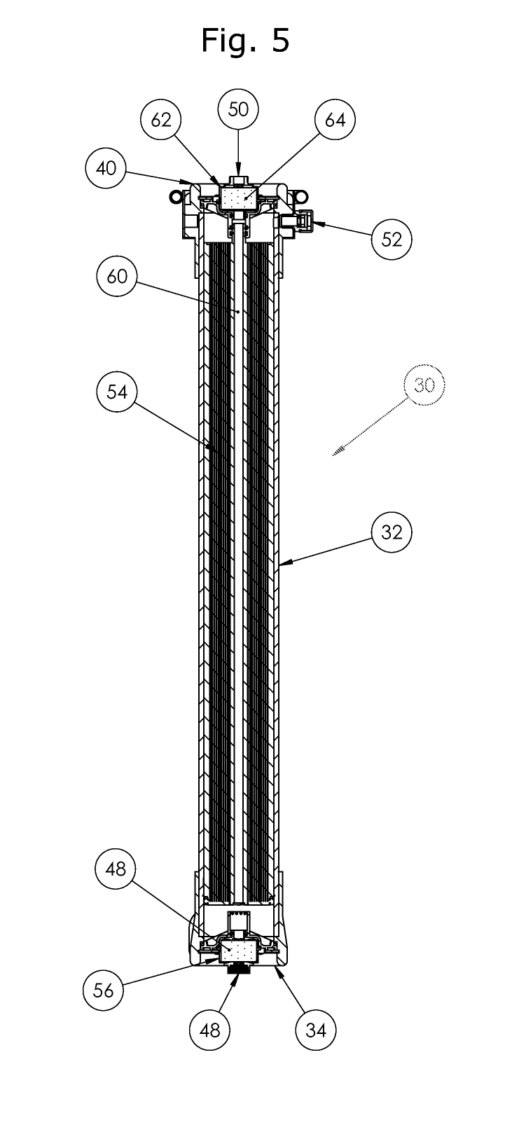

FIG. 5 illustrates an example of a three-stage water treatment system of the present invention is shown in cross-section along line A-A as shown in FIG. 3.

The pressure vessel 32 is substantially cylindrical. Within the interior of the pressure vessel 32 is a substantially cylindrical R/O membrane 54 of the type that can be purchased from Axeon Water Technologies of Temecula, Calif. A suitable membrane is approximately 40 inches in length and approximately 4 inches outer diameter. The membrane is tubular and contains an inner tubular core that accumulates water that passes through the membrane. Water that does not pass through the membrane exits through the concentrate port 52.

At the first end 34 of the pressure vessel, water enters through water supply inlet 48 and passes through a first stage carbon filter cartridge 56 containing a solid block of carbon, having an approximate volume of 3.77 cubic inches and having a porosity between about 6 and about 12 microns, with a preferred porosity of about 10 microns. The details of construction of the carbon filter cartridge 56 are discussed in greater detail below.

In a preferred form of the invention, the carbon filter cartridge 56 contains a solid carbon block 58 that is of a size to treat a total amount of water that is typical for cleaning all the windows of a residential home, cleaning a residential vehicle or for completing another home-washing project. Typically the total volume of water needed to clean all of the windows of a residential house is between 50 and 120 gallons of total water consumption, with an average water consumption of about 80 gallons. Of the amount of water consumption, approximately 1/2 of that volume represents the total amount of purified water made. The desired flow rate of pure water exiting the system is between 0.2 and 1.2 gpm with a more preferred flow between 0.4 and 0.8 gpm with a typical flow rate of 0.5 gpm.

Cartridges 56 of the present invention are preferably disposable, single use cartridges sized to treat between about 80 and about 120 gallons of water, producing approximately half that amount in pure water.

Water exiting the first stage cartridge 56 next enters a reverse osmosis membrane, or R/O membrane. A suitable R/O membrane for this application is rated to process approximately 3000 gallons/day at 77 degrees F. at 80 PSI. The temperature of the water and the pressure of the water supply have a significant impact on the amount of water that can permeate through the filter. One suitable cartridge is a 40 inch long×4 inch diameter R/O membrane, HF5-4040 filter from Axeon Water Technologies of Temecula, Calif. The R/O membrane on the other hand is able to pass water molecules until the membrane becomes fouled. The amount of time until fouling can occur after hundreds or even thousands of uses. As mentioned above, when the membrane fouls, it can be regenerated by washing the membrane with an acid such as muriatic acid or HCL. The R/O filter is not expected to require service until hundreds or even thousands of carbon filters are used.

The carbon/sediment filter removes particles that exceed the size of the pores of the filter, such as suspended particles and also removes large molecular weight molecules such as pesticides, herbicides, pharmaceuticals, fuel and other undesirable contaminants in the water supply. A more detailed discussion of the first stage filter cartridge 56 is provided below.

Water exiting the first stage carbon cartridge 56 next enters the second stage comprising the R/O membrane. The R/O membrane removes approximately 99% of the minerals in the water, including for example, calcium, magnesium and silicates. Purified water accumulates in the core and concentrate that contains the minerals removed from the purified water exit the concentrate port 52, which is described in more detail below.

Purified water exiting the R/O filter next enters a third stage filter cartridge 62 which will be described in greater detail below. This cartridge has an interior cavity that is filled with an ion exchange resin 64. The size of the third stage filter cartridge is sized to hold enough resin to treat the same amount of water to be treated by the first stages, namely 80-120 gallons of feed water in one hour, resulting in approximately 50% purified water and 50% concentrate. The resin can be an anion exchange resin, a cation exchange resin or a mixture of the above. In one preferred embodiment, a resin with a 60% to 40% anion to cation ratio is used. Other ratios such as 50/50, 40/60 and other ratios can be used, depending on the quality of the water being treated.

Advantageously, high quality recycled resins can be used for this application, such as a recycled resin product referred to as MBD-10-NG nuclear grade resin from ResinTech, Inc. of West Berlin, N.J. When the supply water is relatively low in total dissolved solids, it may not be necessary to provide a third stage filter. However, homeowners are not usually aware of the TDS levels of the water supply, and might not be aware of the need for the resin cartridge 62. The last stage of the process essentially removes any remaining ions that could cause glass to streak or cause unsightly spotting. Also, the purer the water is, the more aggressive it is when used as a cleaning solution.

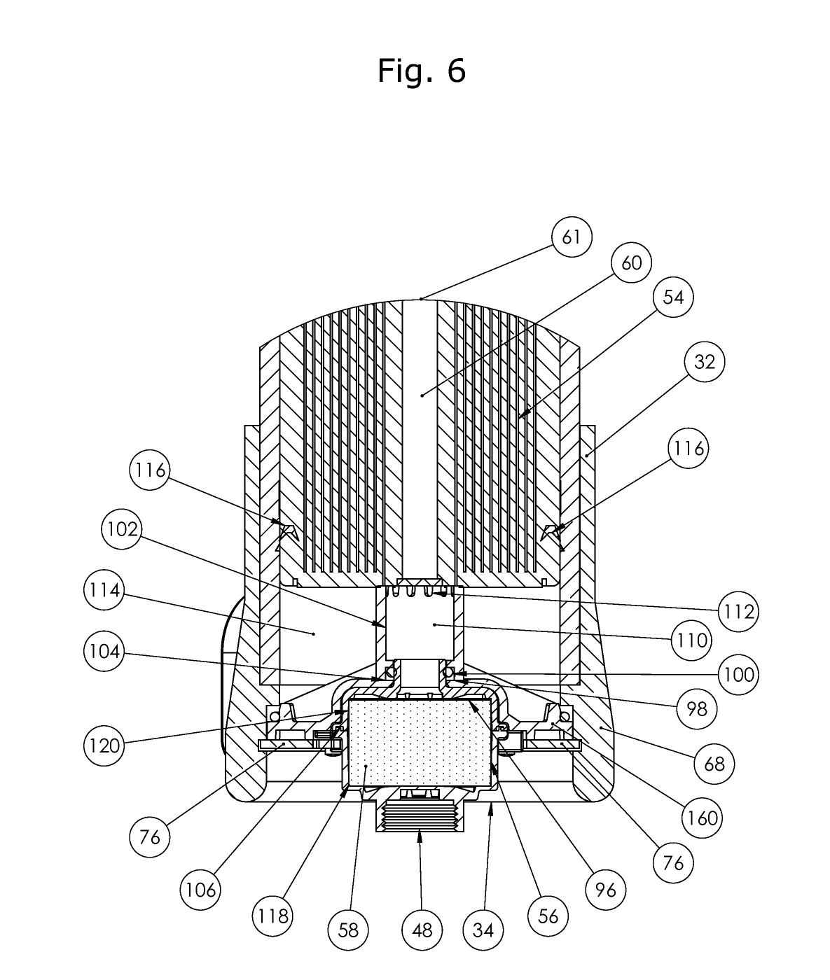

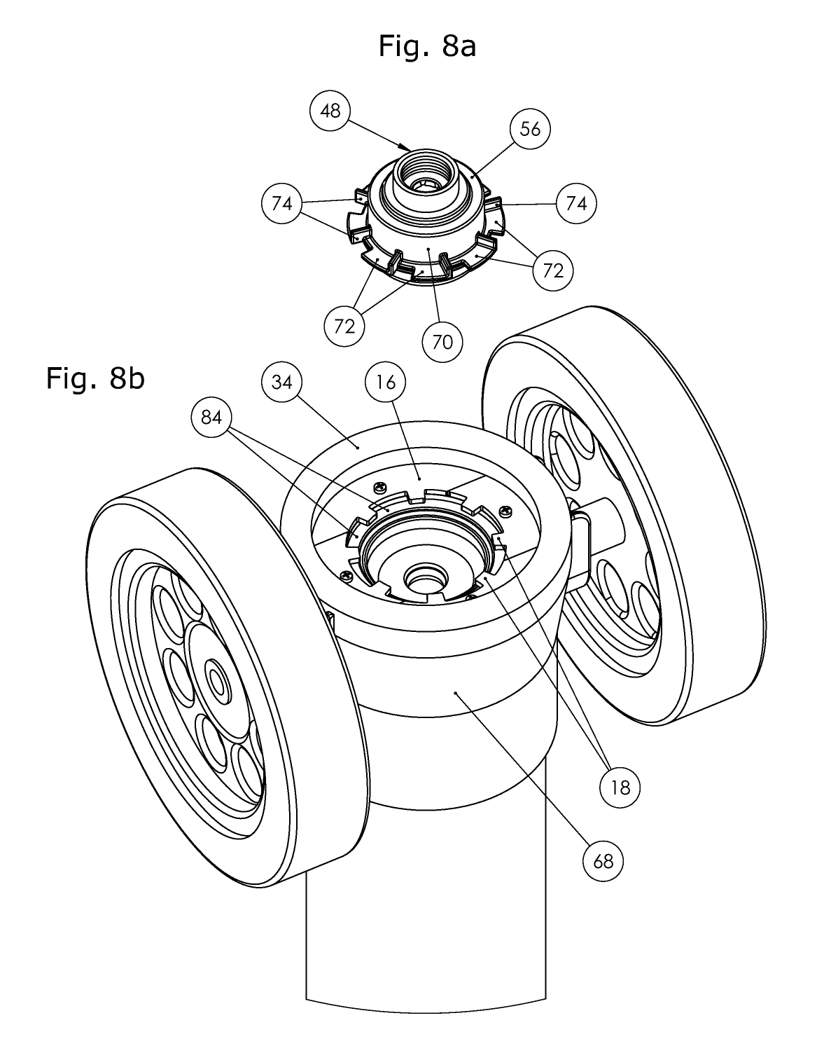

The first stage cartridge 56 is preferably remove ably connected to the pressure vessel cap 68 by means of a quick connect locking system, as shown in FIG. 8. Extending from an outer cylindrical surface 70 of the first stage cartridge 56 are a plurality of radially extending locking tabs 72 and upwardly extending stops 74. Preferably each of the locking tabs 72 is in the same plane and the stops 74 are in a plane that is perpendicular to the plane of the locking tabs 72. The locking plate 76 is mounted within the pressure vessel cap 68 in a groove 108 (shown in FIG. 6). The plate contains a plurality of tabs 78 spaced around a circular opening. Spaced between tabs 78 are a plurality of notches 79 arranged along the same circular opening that are sized to receive locking tabs 72 on the cartridge 56.

To insert the cartridge 56 into the pressure vessel 32, the user first attaches the cartridge 56 to the water supply, such as a garden hose with a male end. The male end of the hose is screwed into the threaded water supply inlet 48, which preferably has female hose threads.

Advantageously, by first installing the cartridge 56 to the end of the garden hose, there is no need to provide a swivel coupling or to twist a long length of hose, which causes kinks in the hose and can stop water flow completely.

Next, the user grasps the outer perimeter 70 of the cartridge 56, and aligns the locking tabs 72 with the notches 79. When the locking tabs 72 are aligned, the cartridge can be lowered onto to support surface 84. The cartridge is then rotated clockwise until the upwardly extending stops 74 rest against a tab 78. In one embodiment, there are 8 tabs and the total amount of rotation to securely lock the cartridge into place is about 22.5 degrees.

Other locking systems with equivalent quick connect couplings can be used to secure the cartridge 56 to the pressure vessel 32. However, it is more desirable to use connection systems that do not require over 180 degrees of rotation in order to avoid the use of swivel couplings on the hose or twisting the water supply hose.

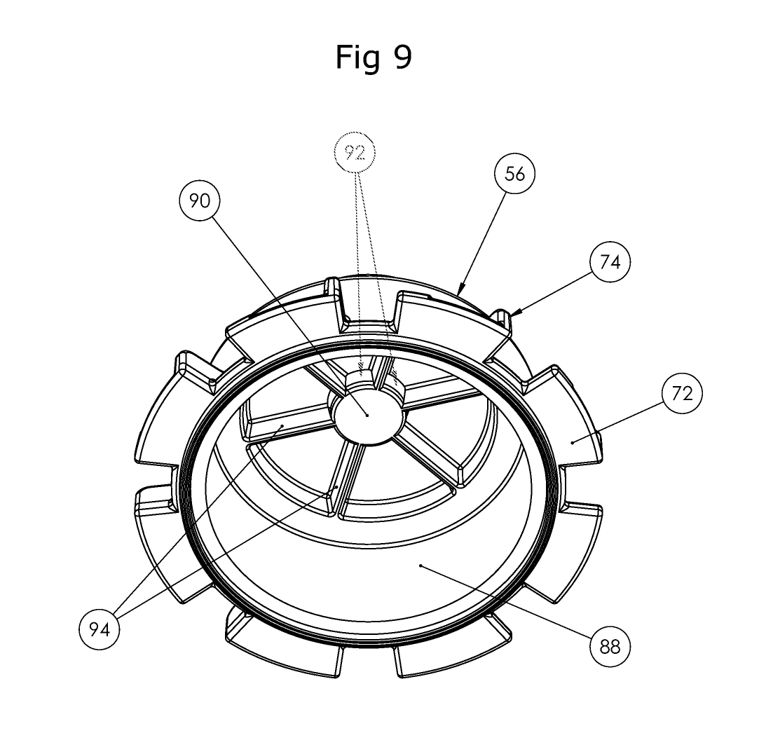

FIG. 9 is a perspective view of a first half of the first stage cartridge 56 as seen from the interior. Water entering cartridge 56 (from behind diffuser plate 90) hits the back side (not shown) of diffuser plate 90 and exits through openings 92, spreading radially outward between radially projecting fins 94 to provide a uniform flow of water over the surface of the carbon block which is in contact with the diffuser plate and fins.

Referring back to FIG. 6, water entering water supply inlet 48 is dispersed over an upper surface of carbon block 58. It is to be understood that systems of the present invention may be operated at virtually any orientation, so references to “upper”, “lower” and the like refer to the orientation shown in the drawings, which does not limit the manner in which the systems can be used. The water exiting the carbon block 58 next passes through a circular membrane 96, which is preferably a 10 micron filter cloth that filters out remaining particulates prior to entering the R/O membrane.

The cartridge 56 has a water outlet 98 with a cylindrical exterior surface. The cylindrical exterior surface of the water outlet 98 mates with a cylindrical opening 102 having an annular cylindrical notch 104 with an o-ring 100 within the notch for forming a liquid-tight seal between the cartridge 56 and the pressure vessel 32.

Water exiting water outlet 98 moves through a channel 110 with multiple terminal openings 112 that extend radially outward into liquid channel 114, which enters openings in the R/O membrane 54. A chevron seal 116 prevents water flowing from channel 114 from traveling along the exterior of the R/O membrane 54.

In one embodiment, the cartridge 56 is color coded or marked in a manner to indicate that it is to be connected to the water supply hose. In one embodiment, the cartridge 56 is green in color and the locking plate 76 is also green in color to indicate to the consumer that the cartridge 56 is to be connected to the water supply, and then installed in the first end 34 of the pressure vessel, near the wheels 36, 38. In one embodiment, the locking plate 76 is formed from a metal material such as stainless steel, 0.120 inch thick, and is not the same color as the cartridge 56. In the embodiment shown in FIG. 8, locking plate 76 is a multiple-part plate for ease of installation into pressure vessel cap 68.

The cartridge 56 is formed from a first section 118 and a second section 120 shown in cross-section in FIG. 6. To fabricate the cartridge, the first and second components 118 and 120 are first formed by injection molding, vacuum forming or other suitable method. One exemplary form of molding is injection molding. Next, the carbon block and membrane are both inserted into the interior cavity of the second component 120. Alternately the carbon block and membrane are inserted into a cavity of the first compartment 118. Next, the two components are joined together at joint 106. According to one method, the joint 106 is formed by ultrasonic welding. Other methods of fusing the two sections together include gluing, solvent bonding, cementing, applying heat and pressure, cold welding, applying epoxy, rotational friction welding, etc.

The two components 118 and 120 that are joined together to form the cartridge 56 housing may be formed of any suitable material capable of holding water at up to about 80 PSI and having sufficient rigidity to retain its shape and form a secure quick connect system. Examples of suitable materials include PVC plastic, fiberglass reinforced plastic or ABS plastic. One exemplary cartridge 56 is formed from ABS plastic.

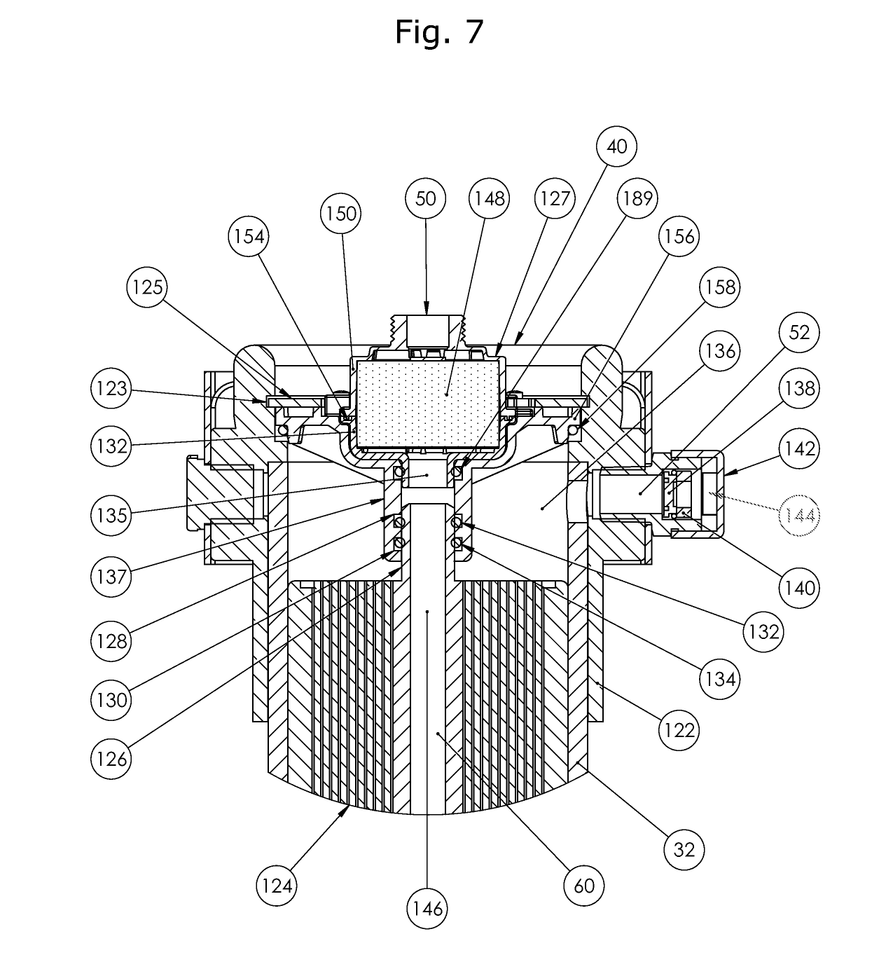

Referring now to FIG. 7, a cross-sectional view of a second end 40 of the pressure vessel 32 is illustrated. The second end of the pressure vessel 32 has a second pressure vessel cap 122. Both caps 68, 122 can be constructed of plastic, such as ABS, PVC or fiberglass reinforced plastic. The caps 68, 122 can be press fit, glued or attached to the wall of the pressure vessel 32 by other means. The second cap 122 includes an annual groove 123 for retaining a second locking plate 125. In one embodiment, the plate 125 is formed from stainless steel in a two-part or three-part construction for ease of installation. The second plate 125 in one embodiment is identical to the first plate 76. In other embodiments, the number of teeth and grooves in locking plate 125 is different than an number in locking plate 76 so that the cartridges 56 and 127 cannot be inserted into the wrong end of the pressure vessel 32. In one embodiment, the color of cartridge 127 is different than the color of cartridge 56. In one embodiment, cartridge 127 is colored blue to indicate the cartridge should be installed on the end 40 that delivers pure water from outlet port 50.

The R/O filter has a terminal end 124 that permits concentrate to exit the filter and collect in concentrate chamber 136. Purified water travels through core 60 in the direction shown by arrow 146.

A cartridge retainer 126 is positioned between the third stage cartridge 127 and the R/O filter terminal end. The cartridge retainer 126 has a tubular first end with two annular grooves 128, 130 extending through an inner cylindrical surface. Each groove contains an o-ring 132, 134, providing a water tight seal against an outer surface of the pure water outlet end of the R/O membrane. Purified water flows through core 60 in a direction shown by arrow 146, into the third stage cartridge 127.

The third stage cartridge 127 has a water inlet 135 and a water outlet 50. In an embodiment, the water outlet has a male hose thread connection. Other methods of connecting a water line such as a hose to connection 50 are contemplated. For example, the outlet 50 can be connected by a pipe connection, a quick connect connection, a swivel connection, a tube fitting or other known connection method. The third stage cartridge 127 may be filled with a resin material 148 such as a 60/40 mixture of cation to anion resin, as described above. The cartridge is sealed to the cartridge retainer 126 by means of an o-ring 137 retained in groove 138 of the cartridge retainer 126.

The third stage cartridge 127 may be formed in first and second sections 150, 152, in the same manner and may be constructed of the same materials as cartridge 56 and have a joint 154 that connects the first and second sections 150, 152. The resin 148 removes any residual minerals that were not removed by the R/O membrane.

In some embodiments, the first and second sections of both cartridges 56 and 127 may have threaded or snap-together joints such that the joint can be separated after use so that a user can refill the cartridges with new carbon material and/or regenerated or new ion exchange resin. If at some point in the future the first and third stage filtering media becomes more expensive, it may be feasible to recycle the first and second sections of the cartridges.

Water that is not able to pass through the R/O membrane contains higher levels of total dissolved solids and is referred to as concentrate. The concentrate exits the terminal end 124 of the R/O filter and accumulates in concentrate chamber 136. Concentrate is expelled through concentrate port 52.

In order to obtain the best performance possible of the R/O membrane, a flow control valve 138 is provided to regulate the flow of concentrate and maintain back pressure in concentrate chamber 136 and on the outside of the R/O membrane surface. In one embodiment, the flow is regulated such that approximately one half of the total flow in is discarded as concentrate. In other examples, between 25% and 75% of the total flow in as is discarded as concentrate.

Concentrate exits through flow control valve 138. In one embodiment, a diffuser 142 is provided to prevent concentrate from spraying out of the outlet port 52. A slot 144 may be provided that allows concentrate to escape radially and fall to the ground.

In other embodiments, the outlet port 52 is connected to a discharge hose and the concentrate is either delivered to a storage vessel or drained onto the ground at another location.

The cartridge retainer 126 may include a groove 139 with an o-ring 137 to seal the outer surface of the cartridge 127 inlet 135 to the cartridge retainer 126. The cartridge retainer also has a groove proximate an outer perimeter and extending downwardly into the concentrate chamber 136 to create a groove to hold an o-ring 158. A similar cartridge retainer 160 exists to support cartridge 56 at the opposite end of the pressure vessel 32.

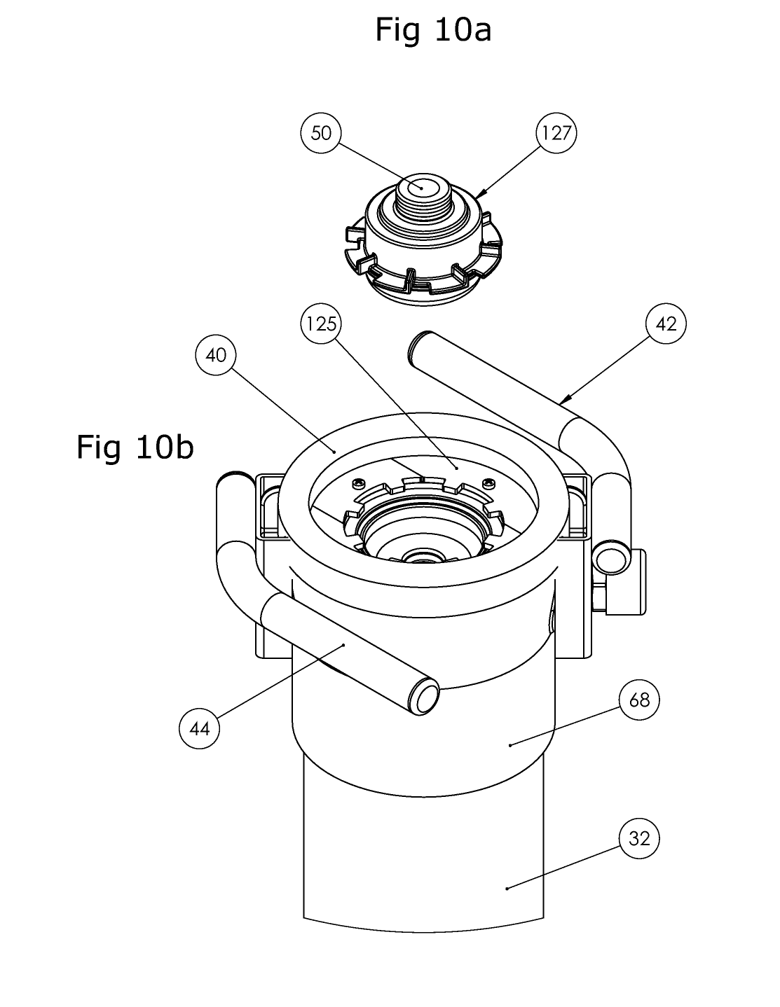

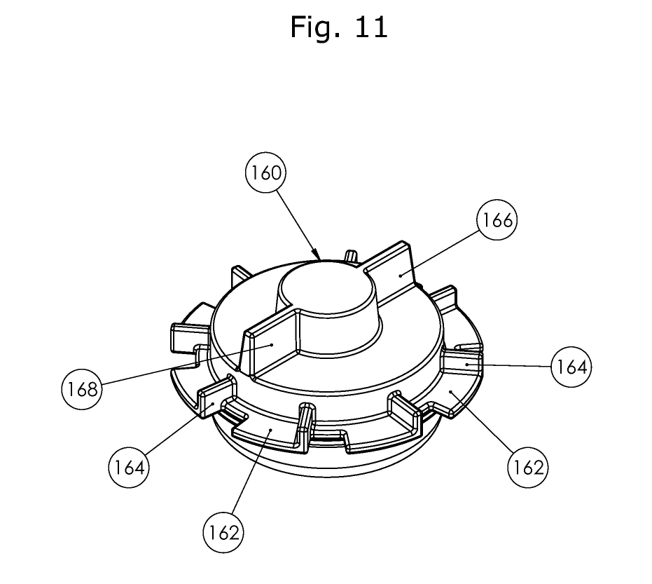

As shown in FIG. 10, third stage cartridge 127 is installed into opposite end 40 of the pressure vessel 32 in the same manner as the first stage cartridge 56 is installed into the first end 34. A user connects the pure water discharge connection 50 to an implement such as a water-fed pole (shown in FIG. 2), or other washing device.

Systems of the present invention are particularly suitable for the consumer rental market. In some embodiments, the pressure vessel 32 and implements are rented. New first and third stage cartridges are provided at the time of rental of the pressure vessel 32. When the pressure vessel is not being used, caps 160 may be installed in the cartridge retainers to prevent water trapped in the R/O membrane from leaking out of the tank. The caps 160 may have a plurality of locking tabs 162 with upwardly extending stops 164 to mesh with the notches in locking plates 76, 125. The caps may include finger tabs 66, 168 may be provided to aid in installing the locking plates.

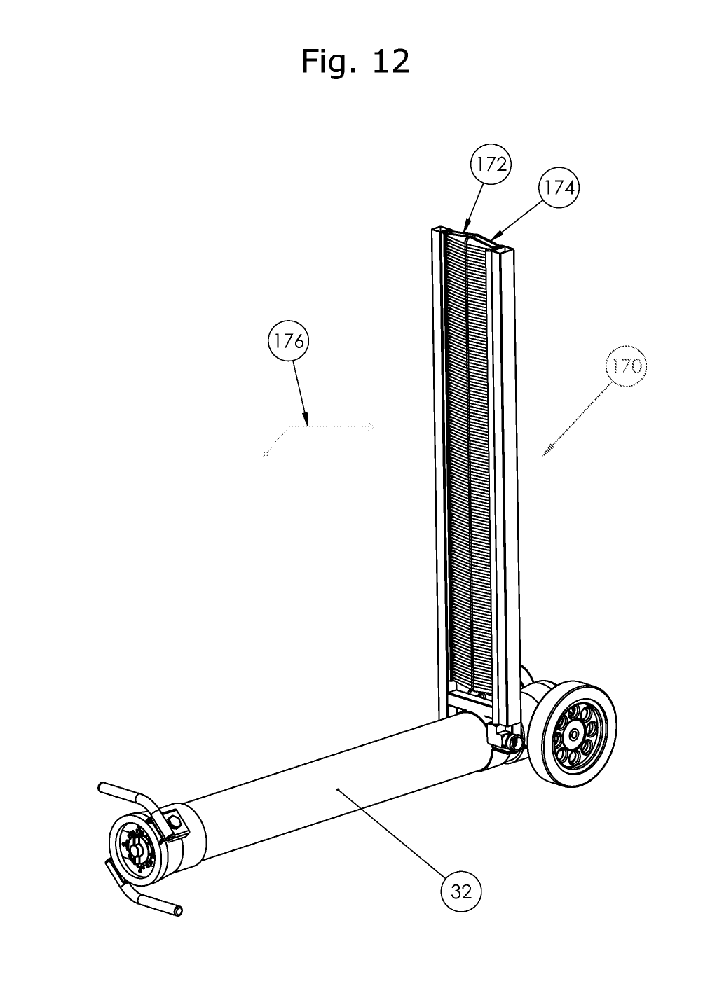

In operation, consumers rent the pressure vessel, which includes one or more implements, such as a pole-fed brush, a screen cleaner, as shown in FIG. 12, a car washing brush on a short pole (not shown) or another known device that cleans smooth surfaces with purified water. As part of the rental agreement, or at an extra expense, the consumer acquires a first and third stage cartridge. The consumer sets up the equipment by first connecting the first cartridge to the water supply and then to the first end of the pressure vessel. The consumer then connects the second cartridge to the implement, and then connects the second cartridge to the opposite end of the pressure vessel. The water is turned on, and the rental unit immediately begins to generate purified water suitable for streak-free and spot-free window washing and other important uses. The user can reach all windows in the house using a telescoping pole and the system delivers enough water at a sufficient flow rate to clean a home with 30+ windows without the quality of the water deteriorating.

As shown in FIG. 12, a screen washing implement 170 may be provided that allows a user to pass window screens through the device and clean them at the same time the windows are being cleaned. This screen cleaning device may be removably mounted to the pressure vessel 32 as shown in the FIG. 12, or may be hinge-mounted to the vessel 32 or may be free standing. The screen cleaning device may be connected to the pure water source, or the garden hose feed water may be used to clean the screens, as water purity is not critical to getting screens clean.

The screen washing implement 170 is formed from two spaced apart brushes 172, 174. Water is sprayed in a manner that is more fully described below. The brushes 172, 174 may be formed of a soft nylon bristle or other suitable material. Screens may be passed through in directions 176 while the water is being dispensed. The combination of water and scrubbing action removes dirt and debris from the screen.

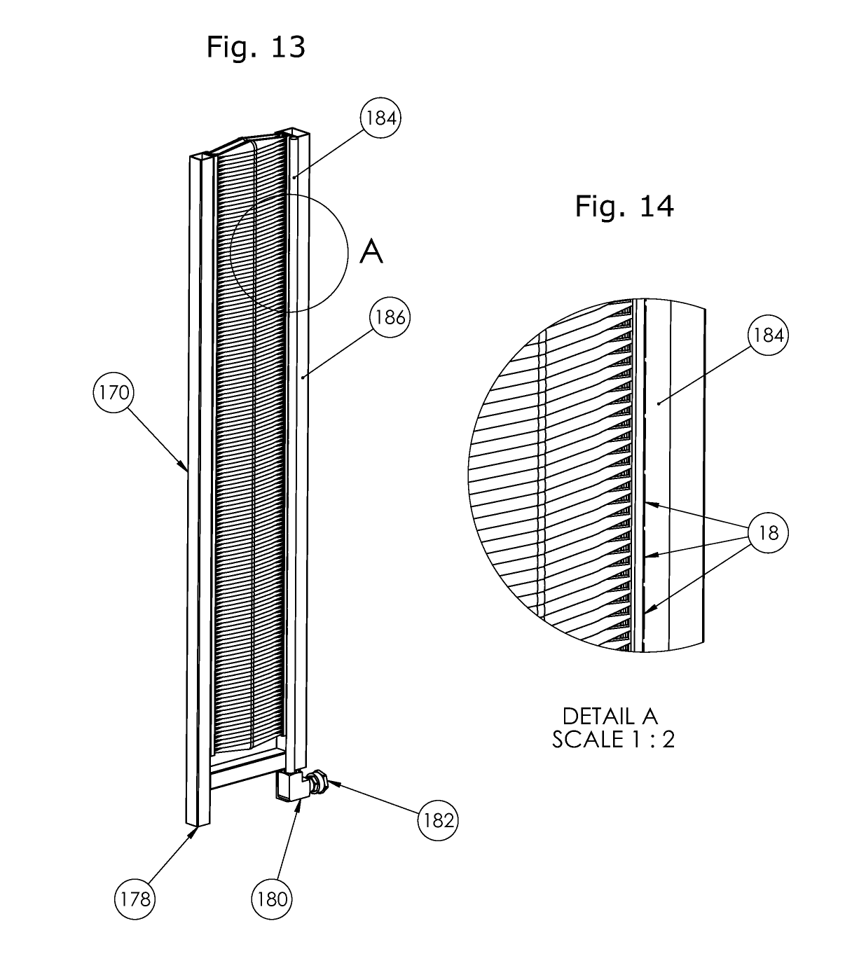

In this embodiment, the pressure vessel 32 is used as a stand to stabilize the screen washing implement 170. As shown in FIG. 13, the vertically spaced brushes may have terminal ends 178, 180 that are insertable into a square or rectangular receptacle in the base member affixed to the pressure vessel 32. Water is supplied to the screen washing implement 170 through a hose connection 182. Water is channeled through a wash tube 184, affixed to a frame 186 of one of the brushes. As can be seen in greater detail in FIG. 14, the wash tube 184 has a series of slotted openings 188 to deliver high pressure water at a substantially 90 degree angle with respect to the face of a screen being cleaned (not shown). The slots provide a spray pattern that effectively removes dirt and debris.

The screen washing implement 170 may be formed with substantially square tubing, equipped with a channel on one exterior face for retaining the bristles of the brush.

In other embodiments, the screen may be provided with its own base so that it is not necessary to use the pressure vessel 32 for support. For example, a separate base may be supplied to stabilize the screen. However, the weight of the pressure vessel filled with water provides extra stability to the screen.

In some embodiments, a screen marking system is provided to enable the user of the screen cleaner the ability to return the same screen to the same window. Two complete sets of stickers are provided. A first set is used to mark the screens, and a second set is used to mark the window frame.

When the user of the screen washing implement 170 is cleaning the screens of an entire structure such as a residential home, often many of the screens are of a different size, making it difficult to sort out, identify and reinstall the screens. To solve this problem, two sets of stickers are provided, one for each screen, and an identically marked sticker for the window frame from which the screen was removed. Preferably the stickers applied to the screens use adhesive that will continue to grip the screen during washing, while the adhesive used on the window frame is less tacky, and more easily removed. According to the method, it may be desirable to keep the markings permanently on the screens. In one embodiment, the screen stickers are transparent and include a number in a dark color, such as black. This sticker can be applied to a corner on the outside surface where it is virtually undetectable from the exterior of the structure. The sticker applied to the window frame can bear the same number, making it a simple task to number match to return the clean screen to the original location.

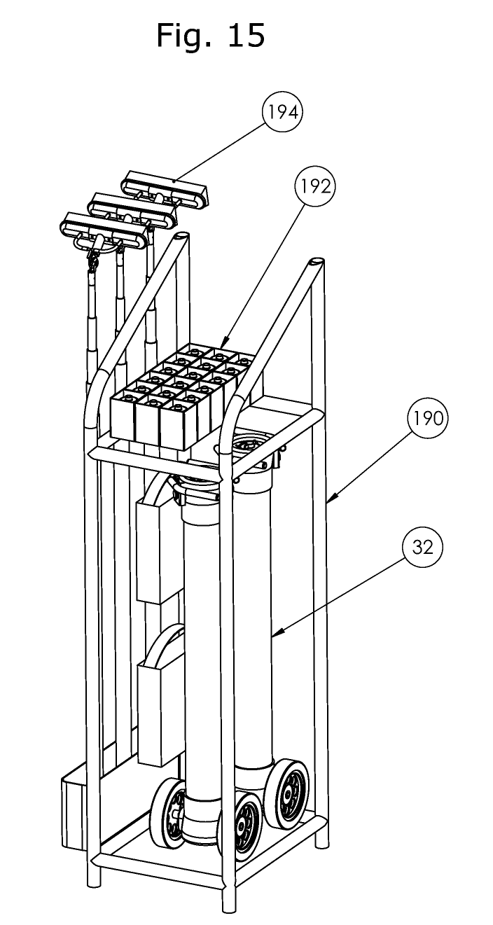

FIG. 15 illustrates a display system for displaying rental systems. The rental system includes a plurality of pressure vessels 32 displayed in a display rack 190. Single use cartridge packs 192 may be presented on the same display rack 190. An area for supporting cleaning implements such as brushes mounted onto telescoping poles 194 may be also be displayed. Users wishing to rent the equipment may select a pressure vessel 32 and pole system 194. The user will purchase a cartridge pack 192. After transporting the system to the structure bearing the windows to be cleaned, the cartridges are attached to the water supply and washing implements, and then to the pressure vessel 32. The water supply is then turned on and purified water is generated and delivered to the pole system 194. Screen washing implements 170 may also be stored in the display rack 190 (not shown).

The embodiments described above are merely examples of the invention, and are not intended to limit the scope of the present invention.

What is claimed is:

1. A system for delivering purified water, comprising:
a pressure vessel with a first end and a second end, each end adapted to receive a single use water treatment cartridge,
first and second single use water treatment cartridges;
wherein the pressure vessel has a first cartridge adaptor at the first end, and a second cartridge adapter at the second end;
a first quick connect coupling between the first cartridge and the first cartridge adaptor, and
a second quick connect coupling between the second cartridge and the second cartridge adaptor.

2. The system of claim 1, and further comprising a reverse osmosis membrane within an interior of the pressure vessel.

3. The system of claim 1, wherein the first cartridge contains carbon.

4. The system of claim 1, wherein the first cartridge contains a sediment filter membrane.

5. The system of claim 1, wherein the second cartridge contains a resin.

6. The system of claim 4 wherein the resin is between a ratio of 40/60 and 60/40 cation to anion resin.

7. The system of claim 1, wherein the pressure vessel has a concentrate exit port.

8. The system of claim 6, and further comprising a flow control valve on the concentrate port.

9. The system of claim 6, and further comprising a diffuser on the concentrate port.

10. The system of claim 1, wherein each cartridge has an outer shell of two-piece construction.

11. The system of claim 9, wherein each cartridge has a joint between the two pieces.

12. The system of claim 3, wherein the carbon is a carbon block having pores between about 8 and 12 microns.

13. The system of claim 11, and further comprising a 10 micron membrane.

14. The system of claim 1, wherein each cartridge has a port with a standard hose connection.

15. The system of claim 1, wherein each quick connect coupling comprises a plurality of radially extending locking tabs extending from an outer cylindrical surface of the cartridges, and locking plates proximate opposite ends of the pressure vessel with grooves sized to accept the locking tabs.

16. The system of claim 1, and further comprising a locking plate proximate each end of the pressure vessel.

17. A method of providing a system for cleaning glass surfaces, comprising:
providing a pressure vessel with a first quick disconnect connection, a second quick disconnect connection and a waste water outlet, wherein the pressure vessel contains a reverse osmosis filter;
providing a first cartridge containing carbon with an inlet connection adapted to connect to a water source and an outlet connection adapted to connect with the first quick disconnect connection;
providing a second cartridge containing a resin material with an inlet connection adapted to connect with the second quick disconnect connection and an outlet adapted to connect to a water supply line of a washing appliance; and
providing instructions for connecting the first cartridge to a water source, connecting the first cartridge to the first quick disconnect connection of the pressure vessel, connecting an outlet connection of the second cartridge to a washing appliance, connecting an opposite end of the second cartridge to the second quick disconnect connection of the pressure vessel, and activating a water source, wherein treated water is delivered to the washing appliance.

18. The method of claim 16, and further comprising providing a water fed pole with a brush mounted at a distal end.

19. The method of claim 16, and further comprising providing a pair of plugs inserted into the quick connect couplings of the pressure vessel.

20. The plugs of claim 19 may contain a media to prevent bacteria growth inside the pressure vessel during storage.

21. A disposable single use water treatment cartridge with a water inlet and a coupling on the water inlet, a central cavity containing a water treatment media, a treated water discharge outlet, and a quick connect coupling on an exterior surface of the cartridge for connecting the cartridge to a pressure vessel.

22. The cartridge of claim 18 wherein the quick connect coupling comprises a plurality of locking tabs that interconnect with a plurality of grooves on a pressure vessel, wherein the cartridge is rotated less than 180 degrees to couple the cartridge to a pressure vessel.

23. The cartridge of claim 18, wherein the water treatment media is selected from the group consisting of carbon, a carbon block, ion exchange resin, cation resin, anion resin and a filter membrane.

24. The cartridge of claim 18, and further comprising an inlet connection and a diffuser on an interior of the cartridge proximate the inlet connection for uniformly distributing water over the water treatment media.

25. The cartridge of claim 18, wherein the water treatment media is a 10 micron carbon block with a sediment filter membrane layer.

26. The cartridge of claim 18, wherein the water treatment media is an ion exchange resin with a 60/40 ratio of cation to anion resin.

27. A method of fabricating a quick-disconnect water treatment cartridge, comprising:
forming a first section of the cartridge, the first section having an a cavity for receiving a water treatment media, a quick connect coupling structure and a joining surface;
forming a second section of the cartridge, the second section having a cavity for receiving a water treatment media, and a joining surface;
inserting and amount of water treatment media into at least one of the cavities sufficient to treat enough water for a single use residential application;
joining together the joining surfaces; and
fusing the joining surfaces together, forming a single use cartridge.

28. The method of claim 24, wherein the joining surfaces are fused by means of ultrasonic welding.

29. The cartridge of claim 24 and further comprising a diffuser plate near an inlet opening for diffusing water over the water treatment media.

30. The cartridge of claim 26, wherein an interior surface of the cavity proximate an inlet opening comprises a plurality of ridges, creating a plurality of flow channels for receiving diffused water.

31. The cartridge of claim 24, wherein the water treatment media is at least one medium selected from the group consisting of a carbon block, carbon granules, sand, sediment filter cloth, anion resin, and cation resin.

32. The cartridge of claim 24, wherein an exterior surface is substantially cylindrical, wherein the quick connect coupling extends radially outwardly in a plane perpendicular to a central longitudinal axis of the cylindrical surface, and further comprising a plurality of radially extending fingers.

33. The cartridge of claim 29, and further comprising a joint extending radially around the cylindrical surface.

34. The pressure vessel of claim 1, and further comprising a screen washing implement mounted on the pressure vessel.
